(19) United States
(12) Patent Application Publication
(10) Pub. No.: US 2026/0288432 A1
(43) Pub. Date: Sep. 24, 2026

(54) SYSTEM AND METHOD FOR DOMAIN SPECIFIC MONITORING FOR APPLICATIONS

(71) Applicant: ORACLE INTERNATIONAL CORPORATION, Redwood Shores, CA (US)

(72) Inventor: Anant ATHALE, Scottsdale, AZ (US)

(21) Appl. No.: 19/415,506

(22) Filed: Dec. 10, 2025

Related U.S. Application Data
(60) Provisional application No. 63/773,843, filed on Mar. 18, 2025.

(51) Int. Cl. G06F 8/41; G06F 8/30; G06F 11/3604

(52) U.S. Cl. CPC G06F 8/443; G06F 8/30; G06F 11/3612

(57) ABSTRACT

Systems, methods, and other embodiments associated with generation of monitoring applications are described. In one embodiment, a method includes generating a domain metamodel from a domain-specific target application. The domain metamodel includes metatags and hints that annotate a source code of the target application to denote domain elements. The method includes specifying relevancies of the domain elements to monitoring of performance characteristics of the target application. The method includes generating, using a code generator, instrumented code for the target application. The instrumented code includes monitoring code configured to monitor behavior of the domain elements. The instrumented code is generated based on the metatags and hints from the domain metamodel. The method includes building, using a compiler and runtime, the monitoring code to produce an executable monitoring application that monitors the target application when deployed in conjunction with the target application.

### CROSS REFERENCE TO RELATED APPLICATIONS

This disclosure claims the benefit of U.S. Provisional Patent Application Ser. No. 63/773,843 filed Mar. 18, 2025, titled “SYSTEM AND METHOD FOR DOMAIN SPECIFIC MONTIORING FOR APPLICATIONS,” having inventors: Anant ATHALE, and assigned to the present assignee, which is incorporated by reference herein in its entirety.

### COPYRIGHT NOTICE

A portion of the disclosure of this patent document contains material subject to copyright protection. The copyright owner has no objection to the facsimile reproduction of the patent document or the patent disclosure as it appears in the Patent and Trademark Office patent file or records, but otherwise reserves all copyright rights whatsoever.

### BACKGROUND

Existing approaches to automatic application performance monitoring suffer from several technical limitations. Conventional monitoring frameworks capture only generic metrics such as latency, throughput, and error rate, without regard to the domain logic or entities of the application being monitored. As a result, these systems lose contextual relationships between monitored events and the underlying code or data structures, delaying or obscuring the identification of performance anomalies. Generic thresholds and static alert conditions frequently cause both false and missed alerts, while manual insertion of instrumentation code remains error-prone and inconsistent across projects. Framework-dependent monitoring tools further lack flexibility to adapt when domain models evolve or differ across environments. Existing systems also fail to prioritize the most critical portions of an application, applying uniform monitoring to low-impact components and wasting resources. Finally, prior automated monitoring lacks reliable mechanisms to validate whether collected metrics accurately correspond to the intended regions of source code. These and other deficiencies in existing monitoring technologies create inefficiencies, inaccuracies, and delays in detecting and diagnosing performance problems.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a monitor generation system that is associated with domain-specific monitoring of applications.

FIG. 2 illustrates one embodiment of a monitor generation method that is associated with domain-specific monitoring of applications.

FIG. 3 illustrates one example of domain-specific monitoring that is associated with domain-specific monitoring of applications.

FIG. 4 illustrates an embodiment of a computing system configured with the example systems and/or methods disclosed.

### DETAILED DESCRIPTION

Systems, methods, and other embodiments are described herein that provide a domain-specific technique for creating application performance monitors, agents and alerts that track quantifiable metrics including latency, throughput and error rate. In one embodiment, a monitor generation system determines various entities included in an application from a domain metamodel of the application, and then generates code of a monitoring application that is specifically configured to monitor performance of the application. For example, the monitor generation system analyzes the structure of a particular domain application under consideration (referred to herein as a “target application”) to create a metamodel that is specific to the domain of the target application, generates instrumentation code for monitoring the target application, and then builds and deploys the monitoring code for execution in concert with the target application. In this way, the monitor generation system automatically develops a monitoring application specific to the domain of the target application based on the structure of the target application itself.

In one embodiment, the monitor generation system generates a metamodel for the domain from the code of the target application. The monitor generation system generates instrumented code for monitoring the target application based on the metamodel. The monitor generation system then builds the portion of the instrumented code that is used for monitoring, and deploys the built code as an application to monitor performance of the target application.

In one embodiment, the monitor generation improves the technology of application performance monitoring in several ways. In previous approaches to application performance monitoring, automatically generated monitoring was limited to capturing generic metrics such as latency, throughput, and error rate by tracking metrics, events, logs, and transactions (MELT). Such monitors are application- and domain-agnostic, potentially ignoring metrics that may be useful or important in a given domain. And, such monitors use generalizations that result in incomplete, out of date, or erroneous metrics. When the monitor generation system is employed, the automatically generated monitoring application shares an underlying domain logic with the application being monitored, enabling domain-specific aspects of performance to be monitored. Thus, in one improvement, monitor generation system increases accuracy of monitoring results (reducing both type 1, false alert and type 2, missed alert errors). In another improvement, the monitoring system increases the speed at which the monitoring results are obtained and delivered because the monitoring application is configured to directly monitor the relevant operations of the target application, rather than awaiting MELT reporting. And, in another improvement, the monitoring system includes domain-specific metrics in the monitoring results, which are unavailable through monitoring MELT.

### Example Technical Improvements

Generic and incomplete monitoring coverage solved. Prior automatic monitoring systems collect only application-agnostic metrics such as CPU usage, memory consumption, latency, throughput, and error rate, failing to capture performance metrics that are specific to the application's domain logic or entities. In one embodiment, the monitor generation system overcomes this limitation by generating monitoring code derived from a domain metamodel that encodes the domain's entities, attributes, and relationships, enabling domain-specific performance data collection.

Loss of context between monitored events and application logic prevented. Conventional monitoring tools observe runtime events but cannot associate those events with the underlying business logic or data model that produced them. In one embodiment, the monitor generation system maintains semantic linkage between monitored events and the source code elements (e.g., annotated entities, attributes, and relationships) from which they originate, preserving contextual meaning in the monitoring results.

High latency and delayed detection of performance anomalies mitigated. In traditional MELT-based systems, metrics are aggregated and transmitted asynchronously, delaying the identification of performance degradation or service-level violations. In one embodiment, the monitoring applications generated by the monitor generation system execute in concert with the target application and share its domain logic, thereby providing near-real-time detection of domain-specific anomalies.

False and missed alerts due to generalization of thresholds reduced. Generic monitors apply uniform thresholds to diverse application components, often producing false positives or failing to trigger alerts in critical areas. In one embodiment, the monitor generation system uses relevancy scores and domain-specific hints to weight monitoring intensity and define thresholds according to the importance and behavior of individual domain elements, reducing both false-alert and missed-alert rates.

Flexibility across diverse programming frameworks and domains achieved. Traditional monitoring solutions depend on framework-specific or library-specific integrations that are difficult to adapt when domain models change. In one embodiment, the monitor generation system automatically generates domain-specific monitoring code from declarative annotations and can operate across multiple frameworks by interpreting standardized metamodel structures, allowing adaptive and maintainable monitoring solutions.

Prioritization of domain elements enabled. Generic performance monitoring treats all monitored components equally, wasting resources on low-impact elements. In one embodiment, the monitor generation system introduces relevancy scoring of domain elements based on profiling data (e.g., execution time, memory use, and processor utilization), allowing the system to allocate monitoring resources dynamically to the most performance-critical areas.

Validation of monitoring accuracy and coverage. Previous automated monitoring approaches lacked mechanisms for verifying that generated metrics corresponded to correct code regions. In one embodiment, the build and runtime process performed by the monitor generation system includes verification steps that confirm each monitoring hook maps to its intended domain element, improving accuracy and trustworthiness of collected data.

### Definitions

As used herein, the term “domain” refers to a specific problem space, subject matter, or context that a software application is designed to operate within, model, or manage. In other words, “domain” refers to the semantic environment and logical structure of the data, entities, and relationships of the application. A domain-specific target application therefore refers to an application that implements functionality specific to one such domain, and the domain metamodel generated by the invention captures the structural and semantic patterns of that domain as expressed in the application's code (for instance, via annotated classes, relationships, and service-level rules).

As used herein, the term “domain element” refers to an identifiable feature of a domain, including a domain-specific entity, relationship, or attribute, that represents a logical component, association, or characteristic within the modeled problem space of an application.

As used herein, the term “domain metamodel” refers to a machine-interpretable description of the structure, relationships, and properties of a domain as represented in an application. The domain metamodel describes the organization and interconnection of entities, attributes, and relationships in a form that can be interpreted by a code generator. For example, the domain metamodel may be expressed via metatags and hints that annotate the source code to denote domain elements.

As used herein, the term “domain-specific” refers to being tailored in scope to a particular domain, such that the structure, logic, or behavior of an application, model, or process reflects the entities, relationships, and rules that characterize that domain. In this context, domain-specific features are derived from and operate according to the semantics of the application's problem space, rather than being generalized or application-agnostic.

As used herein, the term “entity” or “entities” refers to objects or concepts within an application or domain that have a distinct existence and can be uniquely identified, represented, and manipulated in code or data structures. For example, entities include those elements of the domain which are typically represented as classes or objects within the target application. An entity typically corresponds to a real-world or logical object—such as a person, account, device, or record—and may include associated attributes and relationships that define its characteristics and interactions within the domain.

As used herein, the term “attribute” or “attributes” refers to properties or characteristics that describe, qualify, or define an entity within an application or domain. Attributes provide specific details about an entity's state, identity, or behavior, such as names, identifiers, values, or parameters, and may be used to measure or evaluate performance characteristics associated with the entity.

As used herein, the term “relationship” or “relationships” refers to associations or connections between two or more entities that describe how the entities interact, depend upon, or relate to one another within an application or domain. Relationships define the logical structure of the domain by specifying links such as one-to-one, one-to-many, or many-to-many associations among entities, and may govern how data or operations flow between them.

As used herein, the term “instrumented code” refers to source code that has been modified or augmented with additional executable instructions for observing, recording, or measuring the behavior of selected elements of an application during execution.

As used herein, the term “monitoring code” refers to executable instructions that are configured to collect, evaluate, and report performance metrics associated with the execution of an application, including domain-specific metrics derived from the logic of the application. The monitoring code is distinct from the operational code of the target application, it does not perform the primary functions of the target application but instead observes, measures, and analyzes the performance of those functions during execution of the target application.

As used herein, the term “monitoring” or “monitor” refers to the automated collection and analysis of metrics representing operational characteristics of an application, including detecting, recording, and evaluating the performance of domain elements during execution.

No action or function described or claimed herein is performed by the human mind. An interpretation that any action or function can be performed in the human mind is inconsistent with and contrary to this disclosure.

### Example Monitor Generation System

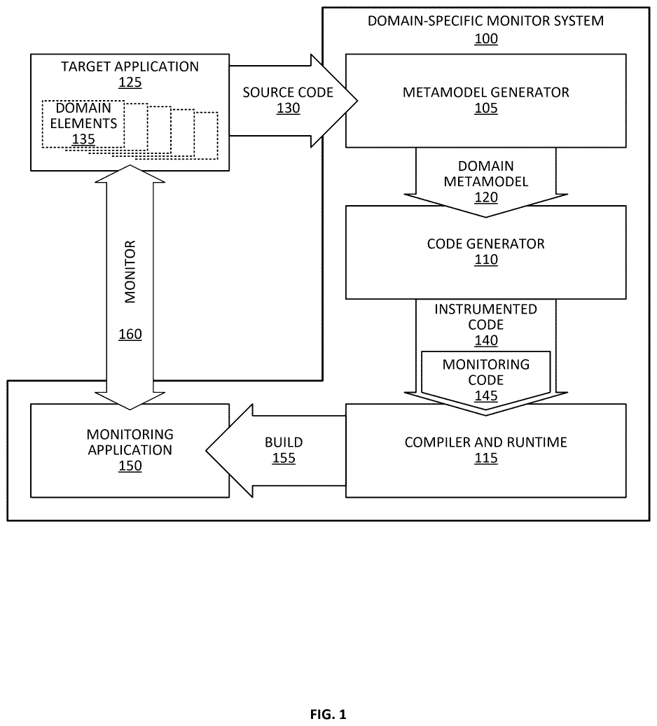

FIG. 1 illustrates one embodiment of a monitor generation system 100 that is associated with domain-specific monitoring of applications. In one embodiment, monitor generation system 100 generates a metamodel for a domain of a target application and then generates and builds instrumented code for monitoring the target application. Monitor generation system 100 has various components, including a metamodel generator 105, a code generator 110, and a compiler and runtime 115. In one embodiment, the components of monitor generation system 100 intercommunicate in a network computing system, for example by electronic messages, as discussed below under the heading “Cloud or Enterprise Embodiments.”

In one embodiment, metamodel generator 105 is configured to generate a domain metamodel 120 from a domain-specific target application 125. The domain metamodel 120 includes metatags and hints that annotate a source code 130 of the target application 125 to denote domain elements 135. In one embodiment, code generator 110 is configured to generate instrumented code 140 for the target application 125. The instrumented code 140 includes monitoring code 145 configured to monitor behavior of the domain elements 135. The instrumented code 140 is generated based at least in part on the metatags and hints from the domain metamodel 120. In one embodiment, compiler and runtime 115 is configured to build 155 the monitoring code 145 to produce an executable monitoring application 150 that is configured to monitor 160 the target application 125 when deployed in conjunction with the target application 125.

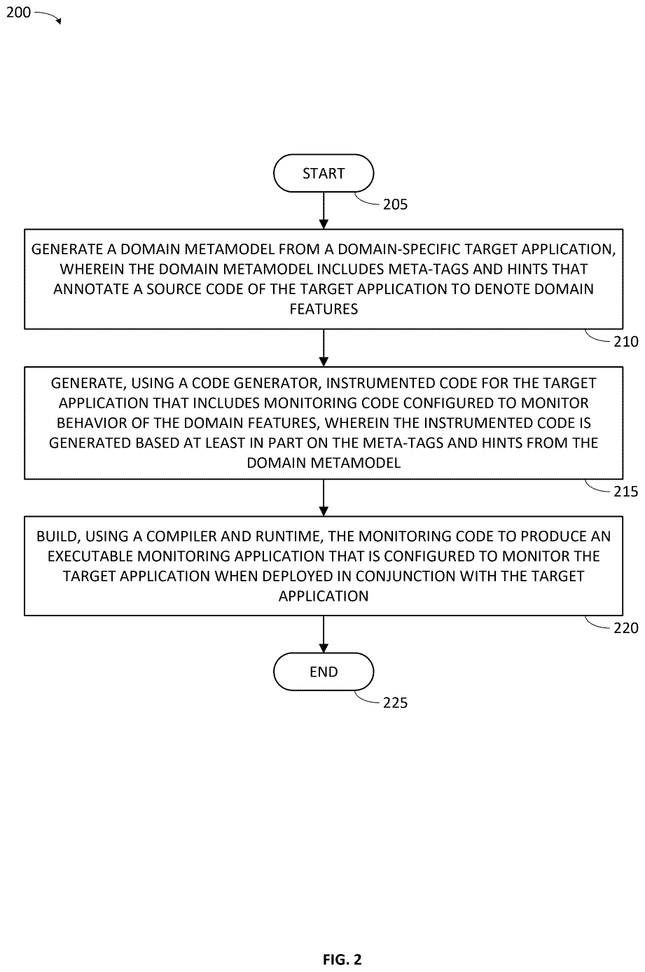

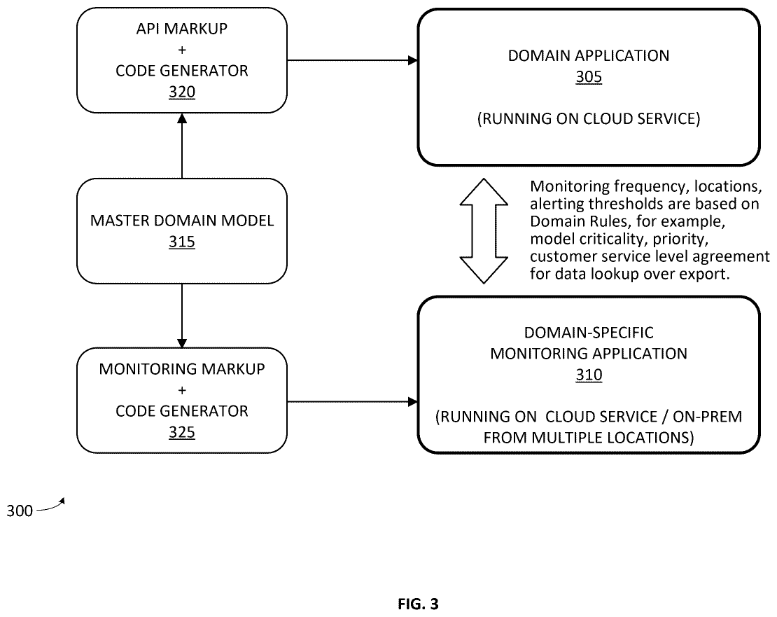

Further details regarding monitor generation system 100 are presented herein. In one embodiment, operations of monitor generation system 100 will be described with reference to monitor generation method 200 of FIG. 2. In one embodiment, an example of domain-specific monitoring by monitor generation system 100 will be described with reference to example deployment 300 of FIG. 3.

### Example Monitor Generation Method

FIG. 2 illustrates one embodiment of a monitor generation method 200 that is associated with domain-specific monitoring of applications. In one embodiment, as a general overview, monitor generation method 200 creates a metamodel for the domain (a “domain metamodel”) of a target application, which denotes elements of the domain (“domain elements”). The domain metamodel is provided as input to a code generator, which converts the domain metamodel into instrumented code for the target application, including monitoring code that specifically monitors the target application. Domain specific monitor method 200 then builds the monitoring code into an executable monitoring application that can be deployed to monitor the target application.

In one embodiment, monitor generation method 200 initiates at START block 205 in response to monitor generation system 100 determining that one or more conditions or events have been detected or have occurred. The conditions or events for initiating monitor generation method 200, include, but are not limited to: (1) monitor generation system 100 has received an instruction to create a domain-specific monitoring application for a target application; (2) monitor generation system 100 has been provided with source code of a target application to be monitored; (3) a user or administrator has initiated monitor generation method 200; (4) it is currently a time at which monitor generation method 200 is scheduled to be run; or (5) some other condition for commencing monitor generation method 200 has been satisfied. As used herein, the use of the term “in response to” an event indicates that an action or task is automatically initiated, carried out, completed, or otherwise performed automatically upon the occurrence of the event.

In one embodiment, a computing system configured by computer-executable instructions to execute functions of monitor generation system 100 executes monitor generation method 200. In one embodiment, at START block 205, monitor generation system 100 configures compute resources for performing monitor generation method 200. (1) monitor generation system 100 provisions (i.e., allocates and initializes) resources of the computing system that are used by monitor generation system 100, such as processor, memory and storage (for example, for executing components of monitor generation system 100). (2) monitor generation system 100 establishes access to one or more networks for the resources, such as access to (a) internal networks for communication among components of monitor generation system 100 and (b) external networks for communication with other computing systems (for example, client systems). (3) monitor generation system 100 connects to data sources (such as databases, data stores, file systems, and cloud storage) used by the monitor generation method 200. And, (4) monitor generation system 100 configures the computing system with system settings, software dependencies and libraries, and modules for executing the components of monitor generation system 100. Following initiation at START block 205, monitor generation method 200 proceeds to block 210.

At block 210, monitor generation method 200 generates a domain metamodel from a domain-specific target application. The domain metamodel includes metatags and hints that annotate a source code of the target application to denote domain elements. For example, monitor generation method 200 analyzes the source code of the target application to determine a structure of a metamodel for the domain of the target application, and denotes portions of the source code that are associated with domain elements.

An example in Java, using JPA (Java Persistence API) for ORM (object relational mapping), shows added metatags inserted into application specific code to denote an entity and various attributes of the entity:

```
@ServiceLevel(availability = ″99.99%″, responseTime = ″100 ms″)
@Entity
@Table(name=”Patients”)
public class Patient {
  // Class body defines a patient entity
  @Id
  private Long id;
  @Column(name = ″lastname″)
  private String lastname;
  @OneToMany(mappedBy = ″patient″)
  private Set<Medication>medications;
}
```

The hint (annotation) @ServiceLevel(availability=“99.99%”, responseTime=“100 ms”) specifies availability and response time requirements for the Patients class. The @ServiceLevel attributes may be obtained from metadata about the source code, such as a SLA (service level agreement) or other metadata source associated with the target application. The metatag (annotation) @Entity specifies that the patient class is an entity and is linked to a database table. And, the metatag @Table specifies a table in a database with which the entity is associated. The metatag @Id indicates that the id attribute is a primary key of the patient entity. The metatag @Column indicates specifics of how the patient lastname attribute maps to a database. The metatag @OneToMany indicates a one-to-many relationship between Patient and Medication entities, and specifies (with the feature mappedBy) the field in the Patient entity that owns the relationship.

In one embodiment of the monitor generation method 200, these metatag annotations may be automatically generated and inserted into the source code of target application by the metamodel generator 105 to generate the domain metamodel. In one embodiment, metamodel generator 105 parses and analyzes the source code 130 of the target application 125 to identify elements—entities, attributes of the entities, and relationships between entities—in the source code 130. Metamodel generator 105 then identifies domain elements 135 within the source code 130 by determining the elements (entities, attributes, relationships) that are to be represented in the domain metamodel.

In one embodiment, metamodel generator 105 identifies domain elements 135 within the source code 130 of the target application 125 by analyzing the structure, semantics, and metadata of the source code 130 to locate portions that correspond to entities, attributes, and relationships. Metamodel generator 105 parses the source code 130 to construct a syntactic representation, such as an abstract syntax tree or symbol table, enabling identification of classes, objects, variables, and methods that define or manipulate data. Metamodel generator 105 then performs semantic analysis of class declarations, data types, inheritance structures, and method signatures to determine which components represent entities, for example, classes that correspond to objects or database tables.

Within the identified entities, metamodel generator 105 detects attributes by locating member variables or properties that store values or states associated with the entity, such as identifiers, names, or configuration parameters. Metamodel generator 105 further identifies relationships by analyzing references, associations, and data mappings (such as pointers, foreign keys, or annotation-based links) that connect one entity to another, including one-to-one, one-to-many, and many-to-many relationships.

If existing annotations or metadata are present in the source code 130, metamodel generator 105 interprets them to confirm or refine the identified entities, attributes, and relationships. Where annotations or metadata are absent, metamodel generator 105 infers equivalent information based on naming conventions, access patterns, or framework-specific constructs. In one embodiment, the inference applies rule-based heuristics and pattern-matching techniques to analyze naming conventions, access patterns, and framework-specific constructs in the source code to identify entities, attributes, and relationships in the absence of explicit annotations. Each detected entity, attribute, and relationship is then recorded as a domain element 135 and incorporated into the domain metamodel 120, which may include metatags and hints inserted into the source code 130 to denote the identified domain elements 135. In this manner, metamodel generator 105 derives a structured representation of the domain from the source code 130 itself, ensuring that the domain metamodel 120 accurately reflects the logical structure and behavior of the target application 125.

Metamodel generator 105 then constructs a domain metamodel 120 based on the entities and relationships identified, thereby mapping structure of the source code 130 to a higher-level representation that describes the domain of the target application 125. Metamodel generator 105 annotates the source code 130 by (1) generating metatags that describe domain elements 135 of the domain metamodel 120 and roles of the domain elements 135 in the domain; and (2) inserting the generated metatags into the source code 130 at appropriate positions, for example by inserting strings (such as “@Entity, @Id, @OneToMany(mappedBy=“patient”), etc.).

In this way, the domain metamodel 120 is incorporated into the application source code 130 in a manner that associates portions of the code with particular domain elements 135. The metamodel generator 105 then outputs the domain metamodel 120 (e.g., as incorporated in the source code 130) for further processing by code generator 110.

In one embodiment, the domain metamodel 120 is written in declarative language such that the domain metamodel 120 specifies what domain elements, relationships, and rules exist and how they are structured, without necessarily describing how those elements are to be executed or processed. For example, the domain metamodel 120 may express the configuration and constraints of the domain in a descriptive format—such as XML, JSON, or YAML—that can be directly interpreted by the code generator to produce corresponding monitoring code. In one embodiment, the annotations inserted by the metamodel generator include declarative language. The declarative language defines domain elements—domain entities, attributes of the domain entities, and relationships between the domain entities—in a format that describes what is represented by the metamodel without detailing how the domain elements are to be processed operationally.

In one embodiment, the domain metamodel 120 includes relevancy scores for the domain elements. A relevancy score describes an extent to which a domain element affects or influences a performance characteristic of the target application. In other words, the relevancy score quantifies the relative contribution of an individual domain element to the performance behavior of the target application. There may be a plurality of relevancy scores for a domain element, each of which relevancy score for the domain element corresponds to a distinct performance characteristic of the target application. The relevancy scores can be used to weight the influence of monitoring of the domain element by a monitoring application.

In one embodiment, to determine a relevancy score, metamodel generator 120 profiles the domain elements to determine performance metrics associated with the elements, such as execution time, memory usage, and processor utilization. In one embodiment, profiling includes execution of the source code with probes to determine values for the performance metrics of the domain elements. The performance metrics for the domain elements may be converted to a relevancy score. In this way, the relevancies of the domain element to monitoring performance characteristics may be specified.

In one embodiment, the steps of block 210 are performed by metamodel generator 105. At the conclusion of block 210, monitor generation method 200 has generated a metamodel for the domain of the target application. In one embodiment, the metamodel is incorporated into the source code of the target application to denote places within the code that are associated with domain elements. The metatags at these locations may further serve to define monitoring points at which hooks for instrumentation may be placed during subsequent code generation. Processing continues to block 215.

At block 215, monitor generation method 200 generates instrumented code for the target application. The instrumented code includes monitoring code configured to monitor behavior of the domain elements. The instrumented code is generated based at least in part on the metatags and hints that are included in the domain metamodel. For example, based on the domain metamodel, a code generator adds monitoring code for observing the behavior of domain elements to the source code. Use of the metatag and hint annotations of the domain metamodel conform the instrumented code to the underlying logic of the domain of the target application. Monitor generation method 200 thus produces code to track how domain-specific elements are performing. The instrumented code generated as described herein conforms the monitoring logic to domain rules specified in the metamodel.

For example, the code generator accepts, as inputs, the domain metamodel written in a declarative language, and source code annotated with the metatags and hints that are included in the domain metamodel. The code generator produces, as output, an instrumented copy of the source code. To produce the instrumented copy of the source code, the code generator generates code that is configured to monitor performance of the entities that are metatagged in the source code as belonging to the domain, and inserts the code into the source code at appropriate locations.

Using the code generator, monitor generation method 200 reads the annotations, parsing the annotated source code to determine what domain elements (e.g., domain entities) are marked to be monitored, and for which performance characteristics the domain elements are to be monitored. For one or more of the annotated domain elements, code generator dynamically generates and inserts code that is configured to monitor a performance characteristic of the domain element. For example, the code generator may insert logging statements into the source code at appropriate locations. The code generator may wrap methods/functions with performance tracking code. The code generator may generate additional methods/functions that evaluate logged information and/or tracked performance against thresholds for alerting. The code generator may generate additional methods/functions for alert mechanisms configured to generate and transmit alerts where logged information or tracked performance satisfies the threshold. In this manner, the code generator produces an instrumented version of the source code that includes inserted monitoring code.

To generate instrumented code for a target application based on source code annotated with the domain metamodel, the monitor generation method 200 parses the annotated source code to identify and interpret the metatags and hints that describe domain elements and their designated characteristics for monitoring. Next, monitor generation method 200 maps these annotations to specific instrumentation tasks, such as logging or performance tracking. Monitor generation method 200 then automatically generates and inserts appropriate monitoring code at designated points in the source code to configure monitoring that is specific to individual domain elements.

The code generator may perform one or more of template-driven or AI-driven code generation. Where the code generator is a template-based code generator, the monitor generation method 200 accesses (e.g., loads from storage) templates that correspond to various types of annotations found in the source code. The templates define how to inject monitoring hooks and instrumentation code around annotated sections of the source code.

For example, a template for an @Entity annotation might inject code to log entry and/or exit points of one or more (or all) methods/functions belonging to a class. Or, for example, a template for an @Attribute might add logging for any access or changes to the attribute. In another example, a template for an @Relationship (e.g., One-To-One, One-To-Many, Many-To-One) might add logging to track interactions that traverse the relationship. As yet another example, a template for an @ServiceLevel(availability=“99.99%”, responseTime=“100 ms”) hint may add (1) logging for success and failure of entering and completing a method/function, along with instrumentation code to calculate the ratio or successful method/function completions vs. total attempts and compare it to the SLA-specified availability rate in the hint; and (2) logging for start and end times of method/function execution, along with instrumentation code to measure elapsed response time and compare it to the SLA-specified response time in the hint.

Where the code generator is an AI-driven code generator, the monitor generation method 200 trains the AI model to understand the context to the source code that is provided by the domain metamodel and annotations. In the training, an AI learns to generate code snippets that are configured for monitoring specific behaviors indicated by the annotations, such as transaction times, error rates, or custom domain-specific metrics.

In one embodiment, the AI-driven code generator is implemented as a large language model (LLM) trained on programming language data, such as a transformer-based model similar to Cohere Command, OpenAI Codex, or GitHub Copilot. The LLM may be fine-tuned on examples of annotated code paired with corresponding monitoring logic, enabling it to learn mappings between specific annotation patterns and the appropriate corresponding instrumentation code.

For AI-driven code generation, the annotated source code and the domain metamodel are converted into a tokenized or embedded representation suitable for machine learning inference. The metatags and hints in the annotated code provides contextual cues about the type of domain element and the performance characteristic to be monitored. The AI model interprets the encoded input to understand what kind of monitoring behavior is required. For instance, annotations indicating service-level metrics or relationships between entities cue the model to generate instrumentation that measures latency, throughput, or dependency timing. Based on this understanding, the AI model produces code snippets that implement the necessary monitoring behavior—such as inserting timers, counters, or log statements—and ensures that the generated code integrates with the surrounding application logic.

After the instrumented code is generated, monitor generation method 200 may extract or separate the monitoring code from the instrumented code. Or, in one embodiment, the monitoring code is stored discretely from the source code, and is not interspersed throughout the source code.

In one embodiment, the steps of block 215 are performed by code generator 110. At the conclusion of block 215, monitor generation method 200 has produced monitoring code (although, in one embodiment, the monitoring code is included in the instrumented code) for a monitoring application that is specific to the target application. Processing continues to block 220.

At block 220, monitor generation method 200 builds the monitoring code to produce an executable monitoring application. The executable monitoring application is configured to monitor the target application when deployed in conjunction with the target application. In one embodiment, the executable monitoring application shares underlying domain logic with the target application to improve accuracy and timeliness of performance monitoring.

In one embodiment, during the build process, compiler and runtime 115 interprets the metatags, hints, and relevancy scores of the domain metamodel 120 to determine which monitoring modules, thresholds, and dependencies are to be included in the executable. Compiler and runtime 115 links the generated monitoring logic to interfaces of the target application. This linking resolves domain-specific APIs and dependencies (i.e., automatically identifies, locates, and connects to components, libraries, or interfaces of the target application that the generated monitoring application must interact with to monitor the target application correctly) so that monitoring operations remain synchronized with application execution. The build may further include verification steps to confirm that the inserted monitoring hooks correspond to the intended domain elements and that metrics can be successfully collected during runtime.

Monitor generation method 200 deploys the monitoring application alongside the target application, to actively monitor performance of the target application in real-time environments. For example, the monitor generation method 200 automatically installs and launches the monitoring application in an environment shared with the target application. The monitor generation method 200 starts to monitor the target application using the monitoring application that has been generated. The deployment may include registration of the monitoring application with system telemetry, event, or alerting services to enable automated reporting and visualization of the collected metrics. The compiler and runtime 115 may also apply relevancy scores determined for the domain elements to adjust monitoring intensity or sampling frequency, prioritizing domain elements that have the greatest influence on overall application performance.

In one embodiment, the monitor generation method 200 creates one or more configuration scripts that define how the monitoring application connects to the target application, such as by specifying environment variables, configuration files, and network settings that align the monitoring setup with the operating environment of the target application. This information may be fetched from a configuration service associated with configuring the target application. The configuration scripts include instructions (e.g., configuration bindings) for connecting the monitoring application to services outside of the monitoring application (such as those in the target application) that are used by the monitoring application. As may be needed, the monitor generation method 200 may also package the monitoring application with any dependencies or configuration files used for executing the monitoring application that are not available from the environment that is configured for executing the target application. In one embodiment, compiler and runtime 115 generates these configuration bindings automatically based on information derived from the domain metamodel, ensuring that the monitoring application inherits consistent connection parameters and service dependencies from the target application.

The monitor generation method 200 then performs an automated deployment of the monitoring application. In one embodiment, orchestration tools such as Ansible, Terraform, or Kubernetes executes the previously prepared configuration scripts to deploy the monitoring application alongside the target application. And, the orchestration tools executes startup scripts to initialize the monitoring application, for example by configuring logs, starting performance counters, and establishing connections to the target application. The automated deployment may further include dynamic scaling or container orchestration to ensure adequate resource allocation for domain elements with high relevancy scores or critical service-level indicators. Upon initialization, the monitoring application verifies communication with the target application and confirms readiness to collect domain-specific metrics.

The monitoring application then proceed to capture metrics from the target application, for example in real-time. This may include metrics such as CPU usage, memory, usage, response times, and error rates for particular domain-specific entities (such as those specified in previous steps of monitor generation method 200. Where the metrics satisfy thresholds for which an alert is specified, the monitoring application generates an electronic alert regarding the particular metrics and domain-specific entity for which the metrics satisfied the threshold.

In one embodiment, the monitor generation system includes verification steps that confirm each generated monitoring hook corresponds to the correct region of source code identified in the domain metamodel. For example, the monitor generation system may perform static validation to trace each inserted hook to its originating metatag or hint, verifying alignment of class names, method signatures, and data types with the annotated domain element. During compilation, the system ensures that all references and bindings resolve to valid symbols associated with the intended entities or attributes. Following build, lightweight execution tests confirm that output metrics and logs originate from the correct functions and that their identifiers match those specified in the metamodel. These automated verification steps establish a deterministic mapping between annotations, generated instrumentation, and runtime telemetry, ensuring that monitoring behavior remains consistent with the structure and semantics of the domain logic of the target application.

In one embodiment, the steps of block 220 are performed by compiler and runtime 115. At the conclusion of block 220, monitor generation method 200 has generated an executable monitoring application that is specifically configured to monitor the target application. By building, linking, and deploying the monitoring application in this manner, the monitor generation system produces a domain-consistent monitoring solution that reduces monitoring latency, increases accuracy of performance insights, and provides contextually relevant alerts aligned with the operational behavior of the target application. Processing continues to END block 225, where monitor generation method 200 concludes.

Thus, in one embodiment, monitor generation method (1) analyzes a domain-specific target application to determine information representing entities, relationships, or attributes associated with a domain of the target application; (2) creates, based on the determined information, a domain metamodel that describes structure or behavior of the domain; (3) generates instrumented code for the target application that includes monitoring logic configured to obtain performance information associated with operation of one or more domain elements defined in the domain metamodel; and (4) builds and deploys an executable monitoring application that incorporates the monitoring logic and is configured to monitor execution of the target application.

In one improvement to the technology of performance monitoring, the executable monitoring application that has been generated shares domain logic with the target application being monitored.

### Example Additional Features of Monitor Generation Method—

In one embodiment, monitor generation method 200 proceeds to deploy the generated monitoring application and to monitor the target application. For example, monitor generation method 200 automatically deploys the monitoring application in conjunction with the target application. Monitor generation method 200 then executing the monitoring application to monitor the target application for the performance characteristics. Monitor generation method 200 generates an alert in response to one or more of the performance characteristics satisfying a threshold. For example, generating the alert may include logging an error, sending an email, or integrating with an incident management system.

In one embodiment, the domain elements include one or more of domain-specific entities, relationships, and attributes.

In one embodiment, the performance characteristics include a service level indicator for at least one of latency, throughput, and error rate.

In one embodiment, relevancy scores are associated with the domain elements, and used to quantify the contribution of the element towards a measure of performance of the target application. For example, monitor generation method 200 may also include specifying relevancies of the domain elements to monitoring of one or more performance characteristics of the target application. Here, the one or more performance characteristics include a service level indicator for at least one of latency, throughput, and error rate. Monitor generation method 200 weights the entities for monitoring by the respective relevancies of the entities. For example, the entities may be assigned a respective weight as a multiplier in an equation for quantifying performance, where the weight is proportional to a relevancy score for the relevancy of the entity.

In one embodiment, the domain metamodel is written in a declarative language. And, the code generator accepts the domain metamodel written in the declarative language. The declarative language describes the structure, rules, and constraints of a domain at a high level. For example, the declarative language in which the domain metamodel is written may be one of XML (Extensible Markup Language), YAML (YAML Ain't Markup Language), JSON (JavaScript Object Notation), or a domain-specific language that is appropriate for the domain of the target application. Code generators that accept domain metamodels in one or more of the foregoing languages include XJC (XML Java Compiler) JDeveloper, Ansible, Terraform, Swagger Codegen, Quicktype, and others, as well as generative AI.

In one embodiment, building the monitoring code (as described at block 220) further includes building, using the compiler and runtime, configuration bindings to services outside of the monitoring code to produce the executable monitoring application. For example, monitor generation method 200 generates configuration data (e.g., defined in files, databases, or environment variables) and dynamically links the configuration data to the automatically generated code (of the executable monitoring application) for use by the automatically generated code (of the executable monitoring application).

In one embodiment, the code generator is one or more of (1) a template-based code generator and (2) an AI-driven code generator.

The code generator may be a template-based code generator, which employs predefined templates, scripts, and rules to produce code based on specific input parameters or configurations. For example, the template-based generator associates each metatag or hint in the domain metamodel with a corresponding instrumentation template. An individual template defines the monitoring hooks, log schemas, and threshold evaluations to be produced. The generator inserts the resulting code at the specific source locations identified by the annotations. The generator emits configuration bindings (i.e., automatically produces configuration code or files that define how the generated monitoring code connects to and interacts with external systems or services) derived from the hints. This causes the generated monitoring logic to conform to the domain rules of the target application.

The code generator may be an AI-driven code generator, which employs generative artificial intelligence models to produce code based on machine learning algorithms and datasets of existing code. Examples of AI code generators include OpenAI Codex and GitHub Copilot. In one embodiment, the AI-driven generator interprets the structure and context of the domain metamodel and its annotations to guide code generation. The model generates monitoring code snippets that implement the domain rules, service-level indicators, and alert thresholds for the annotated entities, relationships, and attributes. Generation is limited to permissible instrumentation actions and placement points extracted from the annotations, ensuring the output code remains domain-consistent and correctly positioned within the source code.

### Discussion of Domain-specific Monitor Creation

Existing ways to monitor the availability of software systems involves setting up monitors to track metrics, events, logs and transactions (MELT). These monitors may be auto-generated to capture golden metrics such as latency, throughput and error rate. Such monitors are application and domain agnostic and use generalizations that result in incomplete, out-of-date, or erroneous metrics. As an example, the auto code instrumentation of open telemetry is decoupled from the underlying application behavior and provides generic instrumentation for the libraries used by the application. In this application- and domain-agnostic monitoring, the application code itself is not instrumented. Such auto instrumentation provides an incomplete view of the application health and may cause SLA (service level agreement) breach, undetected or late detection of client issues, or other problems.

In one embodiment, the monitor generation system and method overcomes these and other problems using a domain specific instrumentation model and code generation. For example, the monitor generation system and method introduces a new way to generate application and corresponding application monitoring code through the use of a domain model, language, and code generator such that the generated monitoring application shares the domain logic with the domain application being monitored. Because the generated monitoring application shares the domain logic with the domain application, it is therefore sensitive to domain rules such as the model criticality, relationships with other model entities, changes to the underlying model to dynamically derive monitoring set up including alerting thresholds, frequency, SLA's, monitoring locations, etc. This technical improvement over application- and domain-agnostic, generalized monitoring techniques enables the domain-specific monitor generation solution described herein to provide earlier and more accurate views of health of the application than are otherwise available.

As an overview, in one embodiment the monitor generation system includes the following components:
(1) Domain Metamodel—Declarative programming language metatags and hints that annotate the source code for availability monitoring. The metamodel for the domain includes the entities, relationships and attributes. In one embodiment, the metatags and hints are automatically added by the metamodel generator, based on the content and structure of the source code. In another embodiment, the metatags and hints are already present in the source code of the target application.

The metamodel serves to define the model for the domain application in programming language. The domain metamodel is used to describe the domain, defining what kinds of elements or components exist and how they relate to one another. The domain metamodel serves as a formal representation of the structure and logic of the domain of the application, capturing its components—such as entities, attributes, relationships, and rules—in a machine-readable form. The domain metamodel thus encodes the structure of the domain for the application so that the monitor generation system can interpret the logic of the target application and generate corresponding domain-specific monitoring code. The domain metamodel may be used in subsequent code generation to create monitoring code that is tied to the domain. The domain metamodel may be expressed with metatags or hints (or other annotations). For example, a hint may describe a rule, such as “if call fails beyond 99% availability (or takes too much time), generate an alert. A particular SLA can be used to identify the monitors and threshold values. This is one example use case.
(2) Declarative domain language—The language provides the ability to specify the domain model entities and their relevancy scores towards the calculation of application performance monitoring SLIs (Service Level Indicators) for latency, throughput and error rate. In one embodiment, the declarative domain language serves as a schema or syntax by which the structure and behavior of the domain are expressed in a form interpretable by the monitor generation system. The declarative language enables the user or the metamodel generator to define entities, attributes, relationships, and domain rules as descriptive statements rather than executable code. Because the declarative domain language specifies what elements exist and how they relate, without describing how they are executed, this declarative format allows the monitor generation system to automatically interpret the domain logic for code generation. The language also provides constructs for embedding relevancy scores, which quantify the influence of each domain element on one or more SLIs, enabling the code generator to produce monitoring logic that weights its collection and analysis operations according to domain significance.

The metamodel provides the rules for the language, then the language is used by the user to describe the model and define the constructs of the monitoring application. This step makes the model domain-specific. In this context, the metamodel defines the grammar and permissible relationships of the declarative domain language—specifying, for example, that entities may include attributes, that attributes may include performance parameters, and that relationships may include cardinality or dependency rules. The declarative language is then used to instantiate specific domain elements within these rules, such as defining a “Patient” entity with a “Medication” relationship or a “LoanApplication” entity with an “ApprovalRule” constraint. By describing these domain elements and their interdependencies in declarative form, the user or system conveys the operational semantics of the domain to the monitor generation system. This allows the resulting monitoring application to inherit the domain's structural and logical characteristics, ensuring that performance monitoring aligns with the domain logic of the target application.
(3) Code Generators—The system includes a code generator that produces the metatags and hints for an application's source code to produce an instrumented application code. In one embodiment, the code generation may be metadata-driven. The code generator utilizes metadata, hints, or other annotations in the target application to generate equivalent monitoring logic. The target application includes metadata that describes a logic of the target application. For example, the metadata may include annotations (such as those added to describe the domain metamodel), configuration files, or a schema. To generate monitoring code from the metadata, the code generator reads this metadata and generates monitoring code that matches the domain rules (the logical or operational constraints that define how entities within the domain interact, behave, or are evaluated). The code generation serves to generate an application that has the monitoring functions from the instrumented application code based on the metatags.

For example: if the target application has a rule like loan_amount<=$50,000, the code generator can include this rule in the monitoring application to track violations or unusual requests.

In one embodiment, the code generator 110 is a unique, custom code generation tool that accepts monitoring markup (metatags, hints, or other annotations) to source code and generates monitoring instrumentation code for inclusion in the source code.
(4) Code compiler & runtime—The system includes a compiler and runtime that builds the monitoring code and configuration bindings such that result in an executable monitoring app that can be deployed in conjunction with the application binaries. In one embodiment, the compiler and runtime 115 interpret the generated instrumented code and the configuration data produced by the code generator to assemble a deployable monitoring application. The compiler transforms the instrumented source files—containing both operational and monitoring logic—into executable binaries, libraries, or containerized modules suitable for integration with the target application. During compilation, the compiler resolves the domain-specific APIs and dependencies identified in the domain metamodel, ensuring that each generated monitoring component is properly linked to the entities, relationships, and attributes that it is configured to observe. The runtime environment then initializes these components at execution time, loading configuration bindings that define how the monitoring application connects to external services and to the target application's runtime interfaces.

In one embodiment, the compiler and runtime further validate that the inserted monitoring hooks correspond to the intended code regions defined by the metatags and hints in the domain metamodel, thereby confirming that collected metrics are contextually aligned with the monitored domain elements. The runtime also registers the monitoring components with telemetry, logging, or alerting services used by the target application, enabling real-time collection and transmission of domain-specific metrics. Through this process, the compiler and runtime produce a monitoring application that shares the same domain logic, configuration structure, and service dependencies as the target application, resulting in synchronized execution and improved accuracy in the measurement of domain-relevant performance characteristics.

### Example of Monitor Generation

FIG. 3 illustrates one example of domain-specific monitoring 300 that is associated with domain-specific monitoring of applications. In one embodiment, the domain specific monitoring 300 includes a domain application 305 that is the target of domain-specific monitor generation, domain specific monitoring application 310 produced by the domain-specific monitor generation, a master domain model 315, an API markup and code generator 320, and monitoring markup and code generator 325.

Domain application 305 may be an application running on a cloud service, such as on OCI (Oracle Cloud Infrastructure), AWS (Amazon Web Services), Microsoft Azure, Google Cloud, or a variety of other cloud computing platforms. Domain application 305 may be any of a wide variety of applications related to differing domains. As an example, the domain application 305 may be an application operating in a domain dealing with persons, such as Oracle Health. The domain application 305 may include public APIs, such as, in the example of Oracle Health, a master person lookup API, or a duplicate export API. Domain application 305 is monitored by a domain-specific monitoring application 310.

Domain specific monitoring application 310 was generated according to the monitor generation systems and methods described herein. Domain specific monitoring application 310 is configured to monitor performance of domain application 305. Domain specific monitoring application 310 may be run on a cloud service, and/or on-premises. Domain specific monitoring application 310 may operate from multiple locations.

Domain specific monitoring application 310 is configured to monitor domain application 305 at an interval or frequency. Domain specific monitoring application 310 is configured to monitor domain application 305 from particular locations. Domain specific monitoring application 310 is configured to apply particular alerting thresholds when monitoring domain application 305. The monitoring frequency, monitoring locations, and alerting thresholds may be generated, for example, based on domain rules. The domain rules may include, for example, model criticality, priority, and customer SLA (service level agreement) for data lookup over export. Referring again to the Oracle Health example, there may be a service level agreement for lookup of patient data via export, which may dictate domain-specific monitoring frequency, monitoring locations, and alerting thresholds.

Master domain model 315 is one example of the domain metamodels described herein. Master domain model 315 may be a master domain model for persons (e.g., patients), as accessed and used by a healthcare application.

API markup+code generator 320 automates the creation of application code based on API specifications.

Monitoring markup+code generator 325 automates creation of monitoring application code based on the domain metamodel. For example, code generator 110 reads annotations that are included in the domain metamodel to generate domain-specific code for monitoring the domain application. The domain-specific code may be built into domain-specific monitoring application 310, and deployed to monitor domain application 305.

### Example Domain Applications

The following examples illustrate how the monitor generation method 200 produces domain-specific monitoring applications that improve over and outperform generic, domain-agnostic performance monitoring techniques. In each example, the monitor generation system 100 analyzes the source code of a target application to generate a domain metamodel, inserts metatags and hints that denote domain entities, attributes, and relationships, and produces monitoring code that reflects the domain logic of the target application. The resulting monitoring applications monitor performance characteristics that are contextually relevant to the application's domain—such as rule compliance, workflow integrity, or service-level adherence—rather than generic metrics such as aggregate latency or system utilization. These examples demonstrate the improved accuracy, timeliness, and interpretability achieved when the monitoring code is generated from the structure and semantics of the target application itself.

Example 1—Healthcare: Patient Merge Consistency and SLA Monitoring. In one embodiment, the monitor generation method 200 is applied to a healthcare domain application that includes entities such as Patient, MergeRequest, and Medication, and relationships such as Patient→Medication. The metamodel annotations include @Entity Patient, @Relationship OneToMany(Patient→Medication), and @ServiceLevel(availability=“99.99%”, responseTime=“100 ms”). The code generator produces monitoring code that inserts timers and counters within the merge( ) operation when a duplicateGroupId is detected. The generated monitoring code computes merge conflict resolution time and post-merge medication reconciliation errors per patient record, comparing the observed response time to the SLA specified in the hint. Unlike generic performance monitors that only report aggregate latency or error rates, the domain-specific monitoring application generated according to method 200 isolates merge-specific inconsistencies and reconciliation failures tied to the clinical workflow. This enables faster detection of clinically significant data errors and improves SLA compliance for patient-record merges.

Example 2—Finance: Rule-Aware Loan Decision Monitoring. In one embodiment, the monitor generation method 200 is applied to a financial application in the lending domain, where the source code includes a LoanApplication entity having attributes such as loan amount, credit score, and debt-to-income ratio. The metamodel includes hints such as @Rule(“loan_amount<=50000”) and @ServiceLevel(responseTime=“150 ms”). The generated monitoring code logs rule evaluation outcomes, decision latency, and policy conformance for underwriting operations. The monitoring application computes metrics including rule-violation incidence rate and decision latency conformance, weighting the monitored entities according to relevancy scores near defined decision thresholds. In contrast to generic monitoring that reports only transaction throughput or system error rate, the domain-specific monitoring generated by method 200 captures violations of loan policy logic and identifies performance degradation in decision workflows, providing early detection of policy drift and SLA slippage at the point of decision.

Example 3—E-Commerce: Cart-to-Checkout Step Integrity Monitoring. In one embodiment, the monitor generation method 200 is applied to an e-commerce application that includes domain entities such as Cart, CartItem, Order, and Payment, and relationships such as Cart→CartItem. The annotations include @Entity CartItem, @Attribute skuCategory, and @ServiceLevel(responseTime=“200 ms”). The generated monitoring code instruments the checkout process with step-level timers and drop-off counters partitioned by skuCategory, generating performance data for individual stages such as tax calculation, shipping rate retrieval, and payment authorization. Using relevancy scores, the monitoring application prioritizes high-revenue SKU categories for more granular data collection. Generic monitoring approaches measure only aggregate API latency and cannot localize conversion failures or revenue loss to specific categories or process stages. The domain-specific monitoring application produced by method 200 enables precise detection of bottlenecks in business-critical workflows and improves conversion rate analysis by directly correlating performance metrics with commerce domain entities.

Example 4—Supply Chain: Allocation-to-Pickup SLA Monitoring. In one embodiment, the monitor generation method 200 is applied to a supply-chain management application that includes entities such as Order, Warehouse, and Shipment, and attributes such as region, carrier, allocationTime, and pickupTime. The domain metamodel includes a hint @SLA(“dispatch<15 m”). The generated monitoring code measures elapsed time between order allocation and carrier pickup, computes first-scan delays for each shipment, and applies region- and carrier-specific thresholds derived from the SLA hint. The monitoring application increases sampling frequency for warehouses and carriers with high relevancy scores to ensure more accurate coverage of critical fulfillment routes. Generic performance monitoring systems typically record system CPU, memory, or network usage and cannot correlate such metrics with order or carrier performance. The domain-specific monitoring application generated according to method 200 enables cross-entity interval tracking, ensuring compliance with logistics service-level agreements and improving operational predictability across distribution regions.

Example 5—IoT/Telecommunications: Firmware Update Cohort Reliability Monitoring. In one embodiment, the monitor generation method 200 is applied to an IoT or telecommunications management platform that includes entities such as Device, Firmware, and UpdateBatch, and a relationship Device→FirmwareVersion. The annotations include @Entity Device, @Attribute model, @Relationship ManyToOne(Device→FirmwareVersion), and @Hint Alert(“rollbackRate>2% per model-region”). The generated monitoring code measures per-batch update success and failure rates, calculates rollback frequency, and tracks stabilization time per model and region cohort. The monitoring application dynamically increases sampling for high-relevancy device models representing large installed bases. In contrast, generic error-rate monitoring aggregates failures across all devices and obscures region- or model-specific problems. The domain-specific monitoring application produced by method 200 enables rapid identification of defective firmware rollouts and supports automated rollback policies at the cohort level, reducing service downtime and minimizing customer impact.

### Cloud or Enterprise Embodiments

In one embodiment, the present system (such as monitor generation system 100) is a computing/data processing system including a computing application or collection of distributed computing applications for access and use by other client computing devices that communicate with the present system over a network. The applications and computing system may be configured to operate with or be implemented as a cloud service, such as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment, monitor generation system 100 is a centralized server-side application that provides at least the functions disclosed herein and that is accessed by many users by way of computing devices/terminals communicating with the computers of monitor generation system 100 (functioning as one or more servers) over a computer network. In one embodiment monitor generation system 100 may be implemented by a server or other computing device configured with hardware and software to implement the functions and features described herein.

In one embodiment, the components of monitor generation system 100 may be implemented as sets of one or more software modules executed by one or more computing devices specially configured for such execution. In one embodiment, the components of monitor generation system 100 are implemented on one or more hardware computing devices or hosts interconnected by a data network. For example, the components of monitor generation system 100 may be executed by network-connected computing devices of one or more computing hardware shapes, such as central processing unit (CPU) or general-purpose shapes, dense input/output (I/O) shapes, graphics processing unit (GPU) shapes, and high-performance computing (HPC) shapes.

In one embodiment, the components of monitor generation system 100 intercommunicate by electronic messages or signals. These electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of monitor generation system 100 may (i) generate or compose an electronic message or signal to issue a command or request to another component, (ii) transmit the message or signal to other components of monitor generation system 100, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by monitor generation system 100, for example through a web interface server. In one embodiment, the remote computing system may send requests to and receive responses from monitor generation system 100. In one example, access to the information or applications may be effected through use of a web browser on a personal computer or mobile device. In one example, communications exchanged with monitor generation system 100 may take the form of remote representational state transfer (REST) requests using JavaScript object notation (JSON) as the data interchange format for example, or simple object access protocol (SOAP) requests to and from XML servers. The REST or SOAP requests may include API calls to components of monitor generation system 100.

### Software Module Embodiments

In general, software instructions are designed to be executed by one or more suitably programmed processors accessing memory. Software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The entire set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein. In one embodiment, non-transitory computer-readable media may include stored thereon computer-executable instructions for performing the modules or the functions or logic described herein.

In one embodiment, monitor generation systems and methods described herein may be implemented by using a computer program product, comprising computer program/instructions which, when executed by a processor, cause the processor to perform any of the methods described in the disclosure.

### Computing Device Embodiment

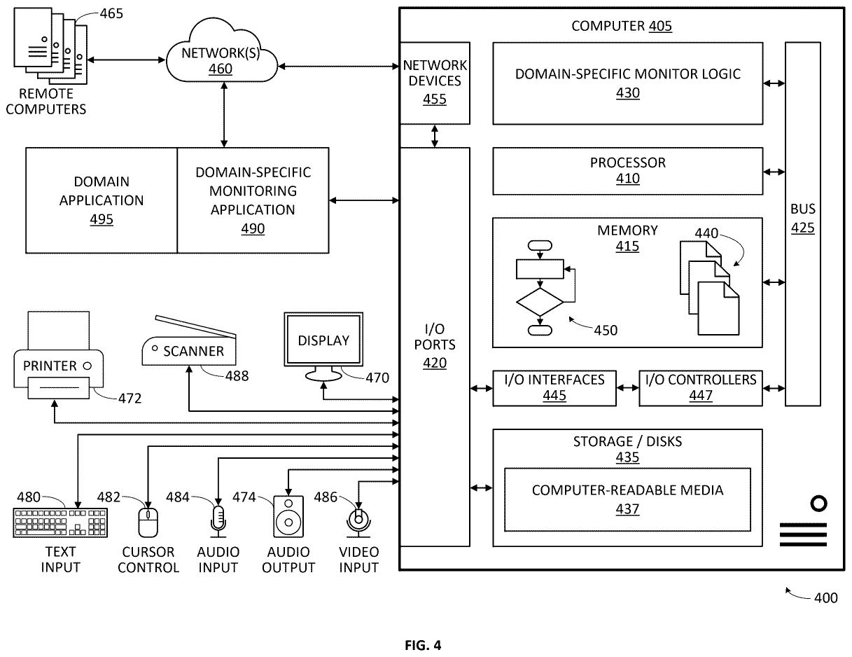

FIG. 4 illustrates an example computing system 400 that is configured and/or programmed as a special purpose computing device(s) with one or more of the example systems and methods described herein, and/or equivalents. The example computing device may be a computer 405 that includes at least one hardware processor 410, a memory 415, and input/output ports 420 operably connected by a bus 425. In one example, the computer 405 may include monitor generation logic 430 configured to facilitate creation of domain-specific application performance monitoring tools to the logic, systems, and methods shown in and described with reference to FIGS. 1, 2, and 3.

In different examples, the logic 430 may be implemented in hardware, one or more non-transitory computer-readable media 437 with stored instructions, firmware, and/or combinations thereof. While the logic 430 is illustrated as a hardware component attached to the bus 425, it is to be appreciated that in other embodiments, the logic 430 could be implemented in the processor 410, stored in memory 415, or stored in disk 435.

In one embodiment, logic 430 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an application-specific integrated circuit (ASIC) programmed to facilitate creation of domain-specific application performance monitoring tools. The means may also be implemented as stored computer executable instructions that are presented to computer 405 as data 440 that are temporarily stored in memory 415 and then executed by processor 410.

Logic 430 may also provide means (e.g., hardware, non-transitory computer-readable medium that stores executable instructions, firmware) for performing one or more of the disclosed functions and/or combinations of the functions.

Generally describing an example configuration of the computer 405, the processor 410 may be a variety of various processors including dual microprocessor and other multi-processor architectures. A memory 415 may include volatile memory and/or non-volatile memory. Non-volatile memory may include, for example, read-only memory (ROM), programmable ROM (PROM), and so on. Volatile memory may include, for example, random access memory (RAM), static RAM (SRAM), dynamic RAM (DRAM), and so on.

A storage disk 435 may be operably connected to the computer 405 via, for example, an input/output (I/O) interface (e.g., card, device) 445 and an input/output port 420 that are controlled by at least an input/output (I/O) controller 447. The disk 435 may be, for example, a magnetic disk drive, a solid-state drive, a floppy disk drive, a tape drive, a Zip drive, a flash memory card, a memory stick, and so on. Furthermore, the disk 435 may be a compact disc ROM (CD-ROM) drive, a CD recordable (CD-R) drive, a CD rewritable (CD-RW) drive, a digital video disc ROM (DVD ROM) drive, and so on. The storage/disks thus may include one or more non-transitory computer-readable media. The memory 415 can store a process 450 and/or a data 440, for example. The disk 435 and/or the memory 415 can store an operating system that controls and allocates resources of the computer 405.

The computer 405 may interact with, control, and/or be controlled by input/output (I/O) devices via the input/output (I/O) controller 447, the I/O interfaces 445, and the input/output ports 420. Input/output devices may include, for example, one or more network devices 455, displays 470, printers 472 (such as inkjet, laser, or 3D printers), audio output devices 474 (such as speakers or headphones), text input devices 480 (such as keyboards), cursor control devices 482 for pointing and selection inputs (such as mice, trackballs, touch screens, joysticks, pointing sticks, electronic styluses, electronic pen tablets), audio input devices 484 (such as microphones or external audio players), video input devices 486 (such as video and still cameras, or external video players), image scanners 488, video cards (not shown), disks 435, and so on. The input/output ports 420 may include, for example, serial ports, parallel ports, and USB ports.

The computer 405 can operate in a network environment and thus may be connected to the network devices 455 via the I/O interfaces 445, and/or the I/O ports 420. Through the network devices 455, the computer 405 may interact with a network 460. Through the network 460, the computer 405 may be logically connected to remote computers 465. Networks with which the computer 405 may interact include, but are not limited to, a local area network (LAN), a wide area network (WAN), and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments. “Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which one or more communication channels are established (or may be established upon request) that allow signals, data messages, physical communications, and/or logical communications to be sent and/or received between the entities. An operable connection may include a physical interface, an electrical interface, and/or a data interface with one or more transmitters and receivers that communicate with wired and/or wireless signals. An operable connection may include differing combinations of interfaces and/or connections sufficient to establish and allow communication. For example, two entities can be operably connected to communicate signals to each other directly or through one or more intermediate entities (e.g., processor, operating system, logic, non-transitory computer-readable medium, internet communication devices, local network, etc.). Logical and/or physical communication channels can be used to create an operable connection. “User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. One or more non-transitory computer-readable media that include stored thereon computer-executable instructions that when executed by at least a processor of a computer system cause the computer system to:
generate a domain metamodel from a domain-specific target application, wherein the domain metamodel includes metatags and hints that annotate a source code of the target application to denote domain elements;
generate, using a code generator, instrumented code for the target application that includes monitoring code configured to monitor behavior of the domain elements, wherein the instrumented code is generated based at least in part on the metatags and hints from the domain metamodel; and
build, using a compiler and runtime, the monitoring code to produce an executable monitoring application that is configured to monitor the target application when deployed in conjunction with the target application.

2. The non-transitory computer-readable media of claim 1, wherein the computer-executable instructions further cause the computer system to:
automatically deploying the monitoring application in conjunction with the target application;
executing the monitoring application to monitor the target application for the performance characteristics; and
generating an alert in response to one or more of the performance characteristics satisfying a threshold.

3. The non-transitory computer-readable media of claim 1, wherein the domain elements include one or more of domain-specific entities, relationships, and attributes.

4. The non-transitory computer-readable media of claim 1, wherein the computer-executable instructions further cause the computer system to:
specify relevancies of the domain elements to monitoring of one or more performance characteristics of the target application, wherein the one or more performance characteristics include a service level indicator for at least one of latency, throughput, and error rate; and
weight the entities for monitoring by the respective relevancies of the entities.

5. The non-transitory computer-readable media of claim 1, wherein the code generator accepts the domain metamodel written in a declarative language.

6. The non-transitory computer-readable media of claim 1, wherein the computer-executable instructions to build the monitoring code further cause the computer system to build, using the compiler and runtime, configuration bindings to services outside of the monitoring code to produce the executable monitoring application.

7. The non-transitory computer-readable media of claim 1, wherein the code generator is one or more of (1) a template-based code generator and (2) an AI-driven code generator.

8. A computer-implemented method, comprising:
generating a domain metamodel from a domain-specific target application, wherein the domain metamodel includes metatags and hints that annotate a source code of the target application to denote domain elements;
generating, using a code generator, instrumented code for the target application that includes monitoring code configured to monitor behavior of the domain elements, wherein the instrumented code is generated based at least in part on the metatags and hints from the domain metamodel; and
building, using a compiler and runtime, the monitoring code to produce an executable monitoring application that monitors the target application when deployed in conjunction with the target application.

9. The computer-implemented method of claim 8, wherein the domain elements include one or more of domain-specific entities, relationships, and attributes.

10. The computer-implemented method of claim 8, further comprising:
specifying relevancies of the domain elements to monitoring of one or more performance characteristics of the target application; and
weighting the entities for monitoring by the respective relevancies of the entities.

11. The computer-implemented method of claim 10, wherein the one or more performance characteristics include a service level indicator for at least one of latency, throughput, and error rate.

12. The computer-implemented method of claim 8, wherein the code generator accepts the domain metamodel written in a declarative language.

13. The computer-implemented method of claim 8, wherein building the monitoring code further comprises building, using the compiler and runtime, configuration bindings to services outside of the monitoring code to produce the executable monitoring application.

14. The computer-implemented method of claim 8, wherein the code generator is a template-based code generator.

15. A computing system, comprising:
at least one processor connected to at least one memory; and
one or more non-transitory computer-readable media that include stored thereon computer-executable instructions that when executed by at least a processor of a computer system cause the computing system to:
generate a domain metamodel from a domain-specific target application, wherein the domain metamodel includes metatags and hints that annotate a source code of the target application to denote domain elements;
generate, using a code generator, instrumented code for the target application that includes monitoring code configured to monitor behavior of the domain elements, wherein the instrumented code is generated based at least in part on the metatags and hints from the domain metamodel; and
build, using a compiler and runtime, the monitoring code to produce an executable monitoring application that monitors the target application when deployed in conjunction with the target application.

16. The computing system of claim 15, wherein the domain elements include one or more of domain-specific entities, relationships, and attributes.

17. The computing system of claim 15, wherein the code generator accepts the domain metamodel written in a declarative language.

18. The computing system of claim 15, wherein the instructions to build the monitoring code further cause the computing system to build, using the compiler and runtime, configuration bindings to services outside of the monitoring code to produce the executable monitoring application.

19. The computing system of claim 15, wherein the code generator is a template-based code generator.

20. The computing system of claim 15, wherein the code generator is an AI-driven code generator.
